(19) United States
(12) Patent Application Publication
(10) Pub. No.: US 2014/0046945 A1
(43) Pub. Date: Feb. 13, 2014

(54) INDICATING DOCUMENTS IN A THREAD REACHING A THRESHOLD

(71) Applicants: Vinay Deolalikar, Cupertino, CA (US); Hernan Laffitte, Mountain View, CA (US)

(72) Inventors: Vinay Deolalikar, Cupertino, CA (US); Hernan Laffitte, Mountain View, CA (US)

(21) Appl. No.: 14/110,484

(22) PCT Filed: May 8, 2011
(86) PCT No.: PCT/US11/35666

§ 371 Date: Oct. 25, 2013

(51) Int. Cl. G06F 17/30

(52) U.S. Cl. CPC G06F 17/30011
USPC 707/737

(57) ABSTRACT

Documents in a document thread include descriptive terms that have weights. An indication indicates when documents in the document thread reach a threshold of weight for the document thread.

### BACKGROUND

A group of documents can include information on specific topics, and a reader may desire to extract this information from the documents. It can be a labor intensive task for the reader to cull through these documents and extract this information if a large number of documents exist. Furthermore, the reader may not know where the desired the information is located in the documents, or how many of the documents to read in order to obtain the desired information.

### BRIEF DESCRIPTION OF THE DRAWINGS

FIG. 1 is a method for presenting documents according to a score in accordance with an example implementation.

FIG. 2 is a method for weighting documents according to a score in accordance with an example implementation.

FIG. 3 is a display showing email scores and ranks in accordance with an example implementation.

FIG. 4A is a screenshot of email threads in clusters in accordance with an example implementation.

FIG. 4B is a screenshot of a summary of email threads in a single cluster in accordance with an example implementation.

FIG. 4C is a screenshot of an email thread in accordance with an example implementation.

FIG. 5 is a computer with a clustering tool that calculates weights and indicates a threshold in document threads in accordance with an example implementation.

### DETAILED DESCRIPTION

Example embodiments are apparatus and methods that process a thread of documents in order to remove redundant material, weight the documents according to descriptive terms, and present the documents with an indication when the documents reach a threshold of weight for a thread.

Given a group of documents, example embodiments extract a list of descriptive terms from these documents and provide weights to these terms. The descriptive terms and the weights come from applying a clustering algorithm to the group of documents. The documents are preprocessed to remove redundant or duplicative text, and a score is generated for each of the processed documents. This score is based on the number of descriptive terms in each of the documents and the weights for the descriptive terms. The documents are then ordered by date (for example, a date when the documents were written, transmitted, or saved) and presented to a user and/or saved.

A group of documents can include thousands, hundreds of thousands, or millions of different documents, such as emails, text messages, articles, notes, etc. The number and/or length of these documents may be too great for a reader to efficiently or timely review. Example embodiments remove duplicative text from these documents during preprocessing and indicate when a certain percentage of information within the documents is reached. For example, a notification is displayed when ninety percent (90%) of information in a thread of documents is reached. In this example, a user would not have to read an entirety of the thread, but read a portion of the thread of documents until the notification in order to obtain ninety percent of the information in the thread. Thus, the documents are presented such that a reader can obtain knowledge of the content of the document thread by reading a portion or selection of some of the documents, as opposed to reading al of the documents in the thread to obtain this knowledge.

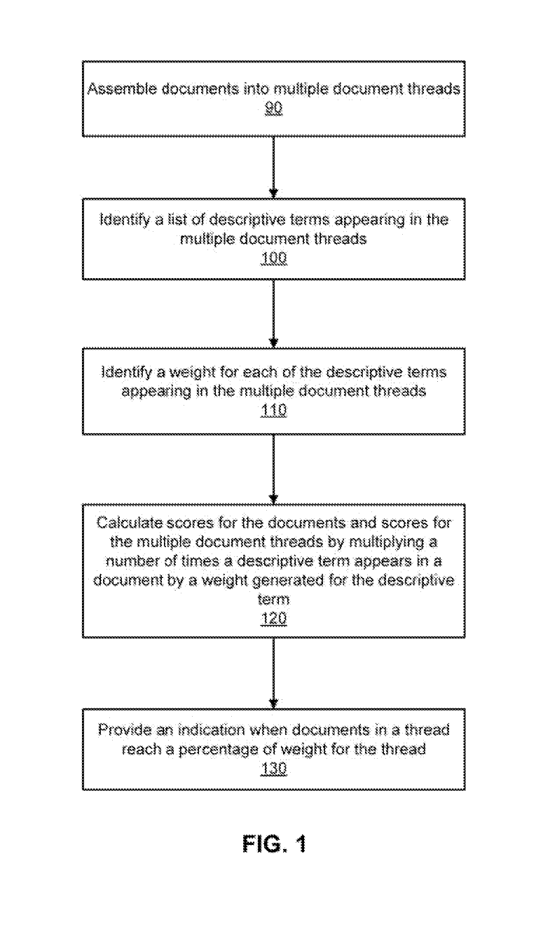

FIG. 1 is a method for presenting documents according to a score in accordance with an example implementation. As used herein, a document is something that conveys information with words. Examples of documents include, but are not limited to, emails, text messages, books, magazines, articles, notes, transcriptions (such as words spoken in a video), and other information containing words (such as words written on a tangible media like paper and/or words stored in an electronic storage medium).

According to block 90, documents are assembled into multiple document threads.

As used herein, a document thread is a series of documents that form a logical discussion or communication. By way of example, text messages in a text message thread form a logical discussion or communication by relating to a topic in the body of the texts, by relating to a sender and/or a recipient of the texts, by relating to a subject or title of the texts, by relating to a time when the texts are sent, and/or by relating to common words or hyperlinks in the body of the texts.

Duplicative or redundant text is also removed from the multiple document threads during preprocessing. This preprocessing can occur before of after the documents are assembled into the multiple document threads.

By way of example, if the document threads are text messages or email messages and include duplicative text, then this duplicative text is removed. Duplicative text can occur when a user responds to an original message and includes a copy of the original message in the response. As another example, information from a first document can be copied and pasted into a second document. This information appearing in the second document is removed as duplicative text since it already appears in the first document.

According to block 100, a list of descriptive terms appearing in the multiple document threads is identified. A user can designate or input the number of descriptive terms. For example, the user can decide to consider ten descriptive terms for the documents in each cluster. These descriptive terms are used when processing the document threads within that cluster. Further, the number of descriptive terms can vary according to user input, such as designating three descriptive terms, four descriptive terms, five descriptive terms, etc. Further yet, the number of descriptive terms can be based on a percentage, such as designating a word as being a descriptive term when the word has a weight of a certain percentage (for example, words with a weight of one percent (1%) or more in a thread are descriptive terms).

According to block 110, a weight is identified for each of the descriptive terms appearing in the multiple document threads. For example, a user specifies a weight for the descriptive terms. Alternatively, weights for descriptive terms are based on word counts, an indexing scheme that identifies a relationship between words and concepts or subjects in a document, and/or a statistical frequency with which the terms appear in the documents, such as a statistical measure using term frequency-inverse document frequency (tf-idf).

According to block 120, scores are calculated for the documents and for the multiple document threads based on the number of times a descriptive term appears in a document and the weight identified for the descriptive term. The scores are thus based on the descriptive terms found in block 100 and the weights for these descriptive terms found in block 110.

For example, if a document includes three descriptive terms (term 1 with a weight of X, term 2 with a weight of Y, and term 3 with a weight of Z), then the score for this document equals (X times the number of times term 1 appears in the document)+(Y times the number of times term 2 appears in the document)+(Z times the number of times term 3 appears in the document).

Each document thread can have multiple documents, with each document and each thread having a score. One example method assembles the threads and removes duplicative content that appears in more than one document (e.g., text that is repeated multiple documents in the thread). The threads are clustered together, and scores are assigned to the clustered threads. Scores are also assigned to unique textual content in documents within each of the threads.

According to block 130, an indication is provided when the documents in a thread reach a threshold or percentage of weight for the thread. This indication can be a visual and/or an audible indication. For example, documents are displayed in a thread until the documents in this thread reach ninety percent (90%) of the weight of the thread according to the descriptive terms and their corresponding weights. After the ninety percentile is reached, subsequent documents in the thread are displayed if the user requests it. As another example, after documents in a thread reach a specified percentage of weight of the thread, subsequent documents in the thread are identified, such as being highlighted, removed from being displayed, marked with a symbol or other visual indication, and/or displayed with text indicating to the user that the documents are below a threshold of weight.

By way of example, the first or earliest message in a thread is maintained in its original form (i.e., with no text removed) and displayed on a screen and/or saved. Subsequent messages in the thread are displayed beneath or after the first message and are ordered according to their date. These subsequent messages have redundant textual content removed such that each subsequent message includes unique content. The subsequent messages retain unique content with respect to the other messages. Consider an example in which a user replies to an original email message, and this reply email includes the content of the original email. The content of the original email appearing in the reply is considered redundant since it already appeared in the original email. Content in the reply email (other than the content of the original email) would be considered unique content since it did not appear in the original email. Another example of redundant text is the inclusion of parts of the original message in the reply message, such as quoting text from an original email in a reply email.

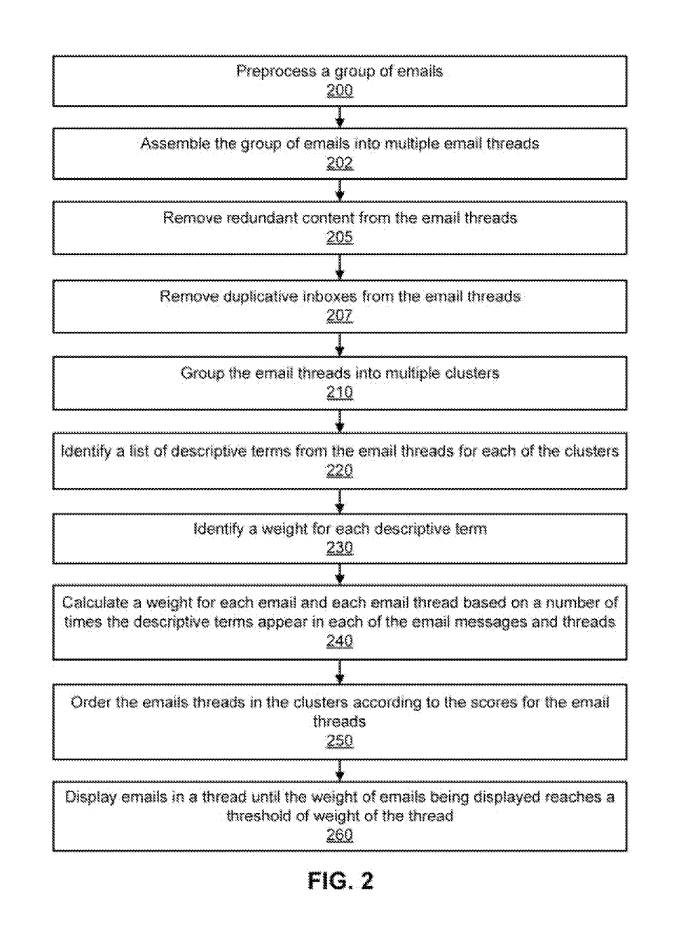

FIG. 2 is a method for weighting documents according to a score in accordance with an example implementation. For illustration, the method is discussed in connection with emails, but the method is also applicable to other types of documents. For example, this method can be applied to a corpus of email messages coming from email inboxes from a large group of users, such as employees of a company.

According to block 200, preprocessing occurs on a group or corpus of emails. During preprocessing, stop words, email headers, signatures, and spurious text are removed from the emails.

According to block 202, the group or corpus of emails is assembled into multiple email threads. For example, the emails are assembled according to a subject line of the emails or information present in the email server storing the emails, such as ordering emails according to sender, recipient, geographical location (for example, emails originating from users a at a specific building), users in a workgroup, etc.

As used herein, an email thread is a series of emails that form a logical discussion or communication. By way of example, emails in an email thread form a logical discussion or communication by relating to a topic in the body of the emails, by relating to a sender and/or a recipient of the emails, by relating to a subject or title of the emails, by relating to a time when the emails are sent, and/or by relating to common words or hyperlinks in the body of the email messages. By way of illustration, two emails are in a thread when they include the same words in the subject line, and they include two common users as recipients or senders of the emails. Also, email threads can be assembled by using email header information, or information present in the email server.

According to block 205, redundant or duplicative content is removed from the email threads. For example, the documents are ordered by date, and duplicative text that occurs in later documents is removed. Spurious text (such as headers, signatures, stop words, etc.) is also removed during the preprocessing.

According to block 207, duplicative inboxes are removed from the email threads so each email is included once in the email thread. A single email message can occur in multiple inboxes when the email is sent from a sender to multiple recipients. For example, if a user sends an email to five different recipients, then this email occurs in the inbox of all five recipients. This email is removed from four of the five recipients so the email occurs once in the email thread.

According to block 210, the multiple email threads are grouped into multiple clusters. As used herein, a cluster is a group of related threads.

For example, a clustering tool assembles or clusters the email threads into clusters or groups. Alternatively, the clustering tool obtains or retrieves the clusters and email threads from memory if clustering has already been performed on the threads. The number of email clusters depends on the number of emails threads and other factors that can be input from a user, such as a range of desired clusters, range of threads per cluster, desired performance/speed of the clustering tool, etc. By way of illustration, an email corpus having 150,000 different threads could be grouped into 30-100 clusters.

According to block 220, a list of descriptive terms is identified from the email threads for each of the clusters found in block 210. For example, the clustering tool generates labels or keywords from the text corpus of emails on the basis of how useful they were in making decisions about to which cluster a particular thread belongs. The clustering tool generates the descriptive terms and weights from a corpus of the threads. For example, the clustering tool assigns a weight to each of the terms appearing in the documents. The descriptive terms are intuitively those words or terms of a corpus such that selecting such a term maximizes the increase of similarity within the objects of each cluster. The weight associated with a descriptive term measures how much of an intra-cluster similarity can be attributed to the descriptive term.

The number of descriptive terms can vary depending, for example, on the number of email threads in a cluster, number of words in the emails, and user input. By way of illustration, an email thread can include about 10-30 descriptive terms (though this number can increase or decrease based on conditions of the corpus and/or user input).

According to block 230, a weight is identified for each descriptive term found in block 220. The weight can be calculated using any one of various methods, such as those discussed in connection with block 110 in FIG. 1. Further, descriptive terms with relatively low weights can be dropped (for example, drop a descriptive term when its weight is under 1% of the total weight for the descriptive terms).

According to block 240, a weight is calculated for each email message and each email thread based on a number of times the descriptive terms appear in each of the email messages and each of the email threads. One example embodiment (a) counts a number of times each descriptive term in the list appears in the email message, (b) multiplies this number by the weight of the descriptive term, and then (c) sums up the numbers calculated in (b). This sum provides a weight for each email message. The counts obtained from (a) can be capped at a user specified number (for example, cap the number of times a single descriptive term appears in a thread or component message to the number 3, 4, 5, etc).

Next, a fraction of the weight of the thread that is contributed by each individual message is computed.

The following illustration in tables 1-5 provides an example of how the calculations in block 240 are executed.

By way of illustration, assume that a cluster of emails discussing storage technology has the following four descriptive terms: storage, SAN (storage area network), server, and disk array. A numerical weight generated for each of these terms is shown in table 1 as follows:

TABLE 1

| Descriptive Term | Weight |
|---|---|
| storage | 30.5 |
| SAN | 21 |
| server | 14 |
| disk array | 8 |

Further, assume that this cluster includes four email threads (email thread 1, email thread 2, email thread 3, and email thread 4). Table 2 shows a count of how many times the descriptive terms appear in each of the email threads.

TABLE 2

| Thread | storage | SAN | server | disk array |
|---|---|---|---|---|
| email thread 1 | 2 | 1 | 0 | 1 |
| email thread 2 | 1 | 3 | 0 | 0 |
| email thread 3 | 3 | 2 | 1 | 1 |
| email thread 4 | 1 | 0 | 1 | 3 |

The number of times a descriptive term appears in each email thread is multiplied by the weight for the descriptive term, as shown in table 3.

TABLE 3

| Thread | storage | SAN | server | disk array |
|---|---|---|---|---|
| email thread 1 | 0 × 30.5 = 0 | 1 × 21 = 21 | 0 × 14 = 0 | 1 × 8 = 8 |
| email thread 2 | 1 × 30.5 = 30.5 | 3 × 21 = 63 | 0 × 14 = 0 | 0 × 8 = 0 |
| email thread 3 | 3 × 30.5 = 91.5 | 2 × 21 = 42 | 1 × 14 = 14 | 1 × 8 = 8 |
| email thread 4 | 1 × 30.5 = 30.5 | 0 × 21 = 0 | 1 × 14 = 14 | 3 × 8 = 24 |

The sum of the weights for each email thread is calculated as shown in Table 4.

TABLE 4

| Thread | Sum of weights |
|---|---|
| email thread 1 | 0 + 21 + 0 + 8 = 29 |
| email thread 2 | 30.5 + 63 + 0 + 0 = 93.5 |
| email thread 3 | 91.5 + 42 + 14 + 8 = 155.5 |
| email thread 4 | 30.5 + 0 + 14 + 24 = 68.5 |

Table 4 shows that email thread 3 has the highest score of 155.5; email thread 2 has the second highest score of 93.5; email thread 4 has the third highest score of 68.5; and email thread 1 has the lowest score of 29.

A fraction or percentage of weight for each email in each email thread is computed. For this illustration, assume that email thread 1 has 3 emails; email thread 2 has 5 emails; email thread 3 has 6 emails; and email thread 4 has 2 emails. Table 5 below shows the fraction of weight that each email contributed to the overall weight for its respective email thread, in Table 5, the term “NA” designates not applicable (i.e., the email thread did not include this number of email messages), and a zero percentage (i.e., 0%) indicates that the email message did not include one of the descriptive terms.

TABLE 5

| Thread | Email 1 | Email 2 | Email 3 | Email 4 | Email 5 | Email 6 |
|---|---|---|---|---|---|---|
| email | 21/29 | 0/29 | 8/29 | NA | NA | NA |
| thread 1 | 72.4% | 0% | 27.6% | | | |
| email | 0/93.5 | 30.5/93.5 | 63/93.5 | 0/93.5 | 0/93.5 | NA |
| thread 2 | 0% | 32.6% | 67.4% | 0% | 0% | |
| email | 91.5/155.5 | 42/155.5 | 14/155.5 | 0/155.5 | 8/155.5 | 0/155.5 |
| thread 3 | 58.8% | 27% | 9% | 0% | 5.2% | 0% |
| email | 38.5/68.5 | 30/68.5 | NA | NA | NA | NA |
| thread 4 | 56.2% | 43.8% | | | | |

Table 5 shows that the first email (Email 1) in email thread 1 has a highest relevancy (724%) to the descriptive terms. The third email (Email 3) in this thread has the second highest relevancy (27.6%), and the second email (Email 2) does not include one of the descriptive terms. This table also shows the relevancy of emails for email threads 2-4.

According to block 250, the email threads in each cluster are ordered according to their respective scores.

Once the email threads are assigned a score, the threads are ordered by score within each cluster. The email thread with the highest score is displayed first; the email thread with the second highest score is displayed second; etc. Further, the emails in each email thread are displayed and sorted by date. The first email is shown in an original or unaltered state, and subsequent emails are shown with duplicative or redundant information removed. For example, if a subsequent email includes the textual content of the first email, then this textual content is removed since it is already presented on the display in the first email.

According to the scores calculated in Table 4, email thread 3 has the highest score of 155.5; email thread 2 has the second highest score of 93.5; email thread 4 has the third highest score of 68.5; and email thread 1 has the lowest score of 29.

The documents are processed such that each document is scored according to the number of descriptive terms and weights for these terms. Additionally processing can also occur. For example, the following is executed for each thread: normalize a score of the thread to 100, start from the top of the thread, and compute a cumulative weight at each component document. A user is notified once a point score of ninety (90) is obtained.

According to block 260, the emails in a thread are displayed until the weight of emails being displayed reaches a specified threshold of a weight for the thread. Emails in a thread are displayed until the emails reach a predetermined percentage of the total weight of the thread. For example, the emails in a thread are displayed until the emails being displayed represent a specified percentage of a total weight for the thread. This specified percentage can be user input (such as eighty percent, eight-five percent, ninety percent, etc.). Subsequent emails can be removed from the thread and not displayed. Alternatively, the subsequent emails can be displayed and visually marked to indicate that they are not within the threshold of weight for the thread.

Subsequent emails in a thread are shown until the sum of the weights of these emails reaches a predetermined value of the total weight of the thread (for example, display emails in a thread until the weights reach 90% of the total weight of the thread). The first lines of each email are displayed along with a list of the inboxes where the email messages were found. Alternatively, a summary of the email can be shown (for example, show the sentences from the email that contain the highest number of descriptive terms).

By way of example, according to Tables 1-5, the email threads and corresponding emails are displayed as follows: (1) Email Thread 3: Email 1. Email 2, and Email 3 (Emails 4-6 are removed from being displayed); (2) Email Thread 2: Email 1, Email 2, and Email 3 (Emails 4 and 5 are removed from being displayed, and Email 1 is displayed even though it has a low score since it is the first email in the thread); (3) Email Thread 4: Email 1 and Email 2; (4) Email thread 1; Email 1 and Email 3 (Email 2 is removed from being displayed).

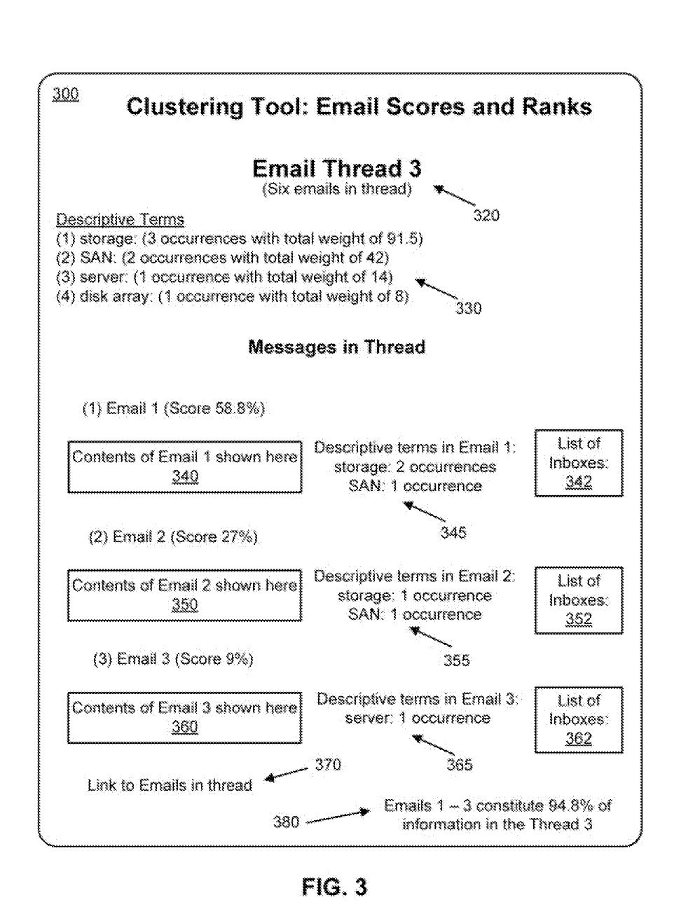

FIG. 3 is a display 300 showing email scores and ranks in accordance with an example implementation. For illustration, some data shown in FIG. 3 is taken from Tables 1-5. A clustering tool scores and ranks email threads and generates output for the display 300.

A cluster includes four email threads (for example, Email Thread 1 to Email Thread 4 shown in Table 5). The email threads are ranked and scored according to the number of descriptive terms appearing in the emails of each cluster. The total weight of descriptive terms from Table 4 is 29+93.5+155.5+68.5=346.5. The respective scores for each email thread are calculated by dividing the weight for each thread over the total weight of the threads. Thus, Email Thread 3 has first rank since it has a score of 155.5/346.5 (44.9%). Email Thread 2 has a second rank since it has a score of 93.5/346.5 (26.9%). Email Thread 4 has a third rank since it has a score of 68.5/346.5 (19.8%). Email thread 1 has the fourth rank since it has a score of 29/346.5 (8.4%).

Since Email Thread 3 has the highest rank, the emails in this thread are presented first, as shown at 320.

Display 300 provides a list of descriptive terms for Email Thread 3, shown at 330. These terms include storage (having 3 occurrences in Email Thread 3 with a total weight of 91.5), SAN (having 2 occurrences in Email Thread 3 with a total weight of 42), server (having 1 occurrence in Email Thread 3 with a total weight of 14); and disk array (having 1 occurrence in Email Thread 3 with a total weight of 8).

The email messages in Email Thread 3 are ordered by date and presented on the display 300 with the earliest email presented first. Email 1 has the highest score of 58.8%. The contents or a portion thereof of the actual email are reproduced at 340 along with a list of inboxes or links 342 to where the email originated (such as link to the inboxes of users that received or sent the email). Also, the descriptive terms 345 found in this email are displayed simultaneously with and adjacent to the email. Email 2 has the second highest score of 27%. The contents of the actual email are reproduced at 350 along with a list of inboxes or links 352 to where the email originated (such as links to the inboxes of users that received or sent the email). The descriptive terms for Email 2 are shown at 355. Email 3 has the third highest score. The contents of the actual email are reproduced at 360 along with a list of inboxes or links 362 to where the email originated (such as a link to the inbox of a user that received or sent the email). The descriptive terms of Email 3 are shown at 365.

FIG. 3 shows contents of emails being reproduced at 340, 350, and 360. The entire contents of an email can be reproduced or a selection of the email can be reproduced. For example, the first five non-quoted lines of each email are reproduced. Alternatively, a summary of the email is reproduced.

Emails and email threads can each have multiple descriptive terms that are displayed adjacent to and simultaneously with the contents of an email message. For example, emails in a thread can have multiple descriptive terms (such as the descriptive terms “storage” and “SAN” appearing in both Email 1 and Email 2 in FIG. 3).

Display 300 also includes a link 370 to each email in Email Thread 3. This link navigates the display to show the actual email.

Display 300 also includes an indication 380 when emails displayed in a thread reach a threshold of unique information of the thread. For example, a visual indication, such as text or indicia displayed on the display, is provided when ninety percent (90%) or more by weight of information in the email thread is displayed. As shown on display 300, the content of Emails 1-3 include 94.8% of unique information for Email Thread 3 (Email 1 with a score of 58.8% plus Email 2 with a score of 27% plus Email 3 with a score of 9%).

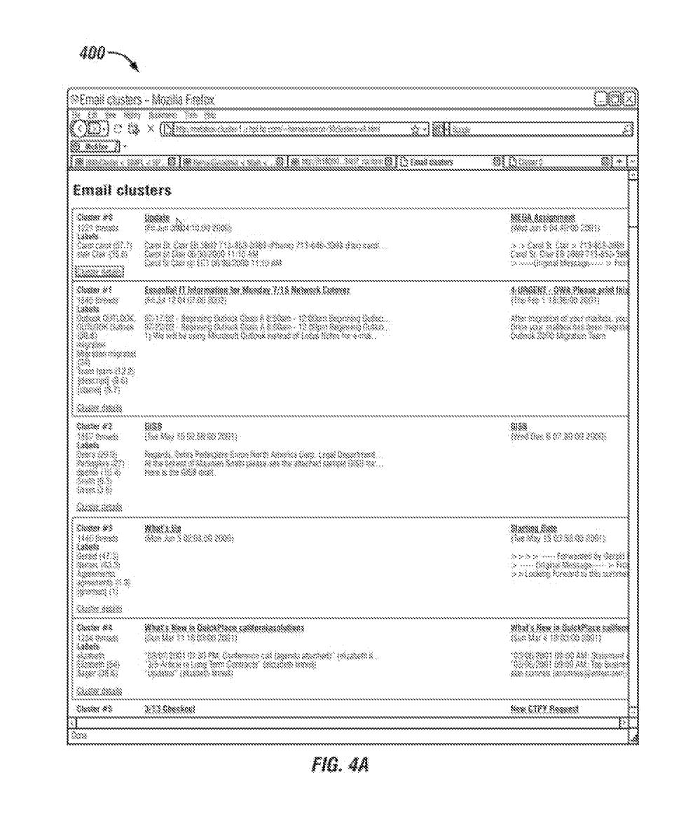

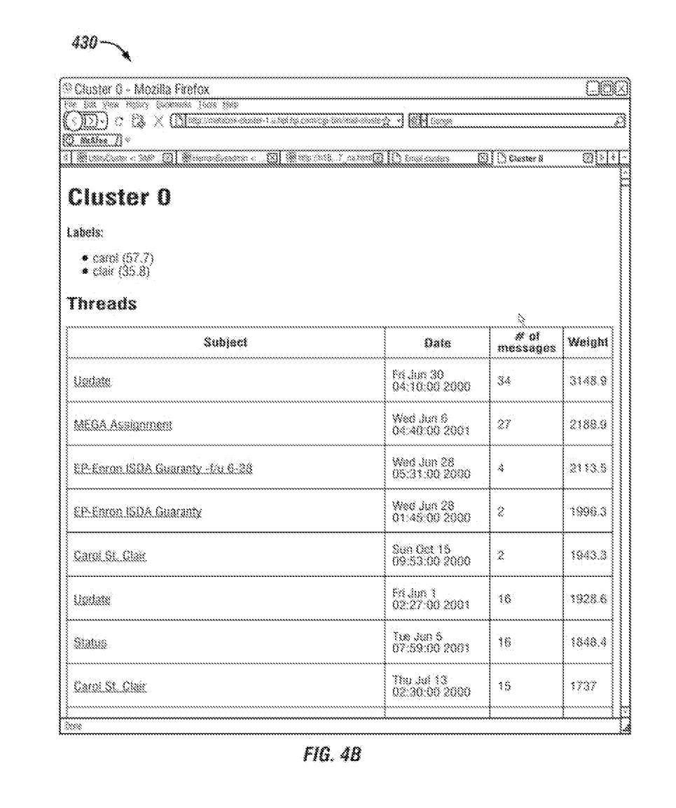

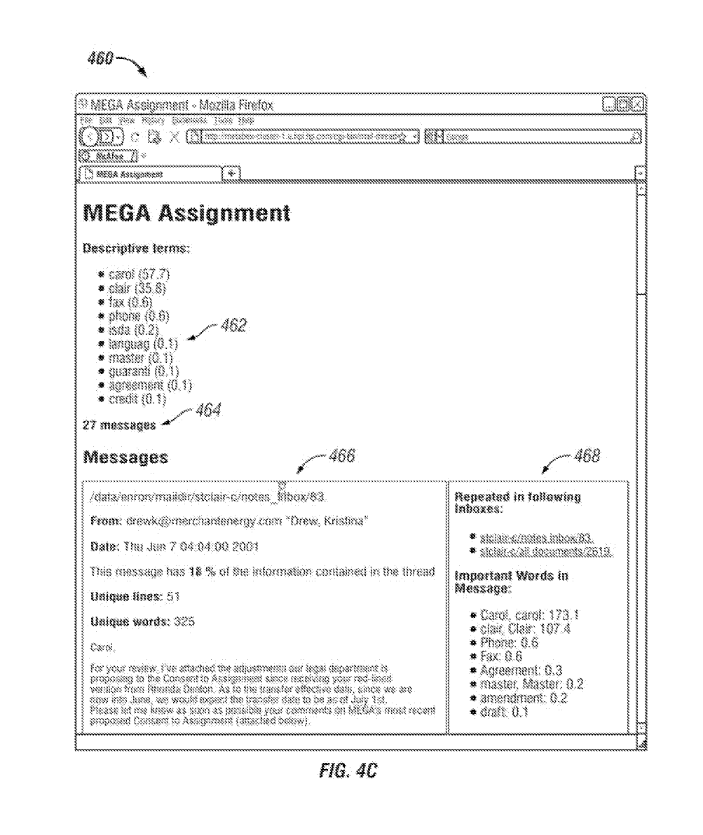

FIG. 4A is a screenshot 400 of email threads in clusters in accordance with an example implementation. Several email threads in each cluster are shown side-by-side. Further information is displayed for each cluster. For example, Clusters #0-#4 include a number of threads in each cluster, descriptive terms and scores for these terms, subjects of threads by weight, dates of emails, etc.

FIG. 4B is a screenshot 430 of a summary of email threads in a single cluster in accordance with an example implementation. Specifically, FIG. 4B shows the summary of email threads for Cluster 0 from FIG. 4A. As shown in FIG. 4B, Cluster 0 has labels or descriptive terms and corresponding scores of “carol (57.7)” and “clair (35.8),” The threads are displayed with subject, date, number of messages, and weight. For example, thread “Update” has a date of 30 Jun. 2000, has 34 email messages, and has a weight of 3148.9.

FIG. 4C is a screenshot 460 of an email thread in accordance with an example implementation. Specifically, FIG. 4C shows the email thread “MEGA Assignment” from FIG. 4B. As shown in FIG. 4C, this email thread includes a list of the descriptive terms 462, a number of messages in the email thread 464, the actual email messages in the email thread 466 (which includes sender of the email, date of the email, unique lines in the email, and unique words in the email), and further information at 468 (which includes links to inboxes where the documents originated and relevant words in the email message).

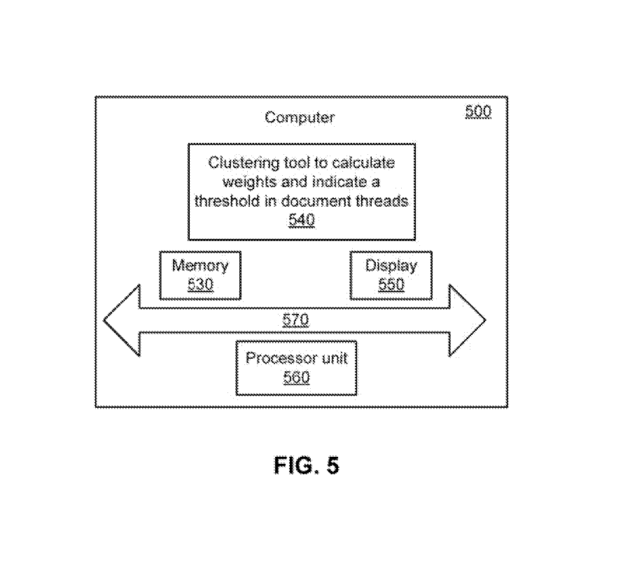

FIG. 5 is a computer 500 with a clustering tool that scores and orders documents in accordance with an example implementation. The computer 500 includes memory 530, a clustering tool that calculates weights for documents and document threads and indicates a threshold in the document threads 540, a display 550, a processing unit 560, and buses or communication paths 570. The clustering tool 540 generates the output shown in display 300 of FIG. 3, generates screenshots of FIGS. 4A-4C, and assists in executing blocks shown in FIGS. 1 and 2.

The processor unit includes a processor (such as a central processing unit, CPU, microprocessor, application-specific integrated circuit (ASIC), etc.) for controlling the overall operation of memory 530 (such as random access memory (RAM) for temporary data storage, read only memory (ROM) for permanent data storage, and firmware). The processing unit 560 communicates with memory 530 and clustering tool 540 to perform operations identified in FIGS. 1-3 and 4A-4C. The memory 530, for example, stores applications, data, and programs (including software to implement or assist in implementing example embodiments) and other data.

Example embodiments can be used in a wide range of applications, such as personal email management, corporate level eDiscovery, and applications that rank and/or score documents.

Blocks or steps discussed herein can be automated and executed by a computer or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit example embodiments.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

What is claimed is:

1) A method executed by a computer, comprising:
assembling, by the computer, documents into multiple document threads;
identifying, by the computer, a list of descriptive terms appearing in the multiple document threads and weights for the descriptive terms;
calculating, by the computer, scores for the documents and scores for the multiple document threads by multiplying a number of times a descriptive term appears in a document by a weight generated for the descriptive term; and
indicating, by the computer, when the documents in the multiple document threads reach a percentage of weight for the multiple document threads.

2) The method of claim 1 further comprising:
calculating a weight for a document thread;
displaying an earliest document in a document thread;
displaying subsequent documents in the document thread until a weight for a document reaches ninety percent of the weight for the document thread.

3) The method of claim 1 further comprising:
removing duplicative text in the documents;
displaying both the documents and inboxes with links to where the documents originated.

4) The method of claim 1 further comprising, displaying with one of the multiple document threads, a list of the descriptive terms appearing in the one of the multiple document threads, a number of times each of the list of descriptive terms appears in the one of the multiple document threads, and a subject for the one of the multiple document threads.

5) The method of claim 1 further comprising, computing a fraction of a weight of a multiple document thread that is contributed by each document in the multiple document thread.

6) A non-transitory computer readable storage medium comprising instructions that when executed causes a computer to:
assemble emails threads of emails into clusters;
identify, for each of the clusters, a list of descriptive terms from the email threads and weights for each of the descriptive terms;
calculate a weight for each of the emails and each of the email threads based on a number of times the descriptive terms appear in each of the emails and the email threads; and
display the emails in each of the email threads with an indication when the emails being displayed reach a threshold of weight of the email threads.

7) The non-transitory computer readable storage medium of claim 6 that when executed further causes the computer to:
display a list of the clusters with descriptive terms and subjects of some threads in each cluster that include top the top threads by weight;
order the emails threads in each of the clusters according to the scores for the email threads.

8) The non-transitory computer readable storage medium of claim 6 that when executed further causes the computer to:
display the email threads according to ranks based on weights of the email threads.

9) The non-transitory computer readable storage medium of claim 6 that when executed further causes the computer to:
remove, from being displayed, emails in a thread that have a weight below the threshold, wherein the emails removed from the thread do not include a sufficient number of the descriptive terms.

10) The non-transitory computer readable storage medium of claim 6 that when executed further causes the computer to:
cap, to a number three, a number of times a single descriptive term appears in an email.

11) A computer, comprising:
a clustering tool; and
a processor to execute the clustering tool to:
obtain a group of emails threads;
calculate weights for emails in the email threads and weights for the email threads based on a number of times descriptive terms appear in the emails and in the email threads; and
indicate when the emails in the email threads reach a threshold of weight for the email threads.

12) The computer of claim 11, wherein the processor further executes the clustering tool to:
display scores for the email threads and rankings of the email threads with respect to each other;
display scores for the emails and rankings of the emails in an email thread with respect to each other.

13) The computer of claim 11, wherein the processor further executes the clustering tool to:
display an indication when ninety percent (90%) or more of information in the email thread is displayed.

14) The computer of claim 11, wherein the processor further executes the clustering tool to:
remove an email from an email thread when a score for the email is below a value;
display the email thread with the email removed;
display, with the email thread, a link to the email that is removed.

15) The computer of claim 11, wherein the processor further executes the clustering tool to:
display an email in an email thread;
display a score for the email with respect to other emails in the email thread; and
display, adjacent to the email, the descriptive terms that appear in the email.
